(19) United States
(12) Patent Application Publication
(10) Pub. No.: US 2025/0060607 A1
(43) Pub. Date: Feb. 20, 2025

(54) BEAM SPLITTER USING MULTI-REFRACTIVE INDEX LAYER AND DEFECTIVE ELEMENT DETECTING DEVICE COMPRISING SAME

(71) Applicants: KOREA INSTITUTE OF MACHINERY & MATERIALS, Daejeon (KR); CENTER FOR ADVANCED META-MATERIALS, Daejeon (KR)

(72) Inventors: Mi Kyung LIM, Daejeon (KR); Jae Hyun KIM, Daejeon (KR); Bong Kyun JANG, Daejeon (KR); Kyung Sik KIM, Daejeon (KR); Hyeon Don KIM, Daejeon (KR); Hak Joo LEE, Daejeon (KR)

(21) Appl. No.: 18/718,603

(22) PCT Filed: Nov. 2, 2022
(86) PCT No.: PCT/KR2022/017074

§ 371 Date: Jun. 11, 2024

(30) Foreign Application Priority Data
Dec. 13, 2021 (KR) 10-2021-0177319

(51) Int. Cl. G02B 27/12; G01N 21/88; G02B 27/00; G02B 27/10

(52) U.S. Cl. CPC G02B 27/12; G01N 21/8806; G02B 27/0012; G02B 27/1013; G01N 2021/8845; G01N 2201/0668; G02B 2207/117

(57) ABSTRACT

Provided are a beam splitter using a multiple refractive index layer, which enables high magnification measurement by transmitting infrared light and reflecting visible light, and a defective element detection device including the same. The beam splitter includes a multiple refractive index layer and a base layer. The multiple refractive index layer is configured to reflect first light and transmit second light having a wavelength longer than a wavelength of the first light. The base layer is provided on one side of the multiple refractive index layer and configured to transmit the second light transmitted through the multiple refractive index layer. The multiple refractive index layer includes a first refractive index layer having a first refractive index and a second refractive index layer having a second refractive index less than the first refractive index.

### CROSS-REFERENCE TO RELATED APPLICATION

This application is based on and claims priority under 35 U.S.C. § 119 to Korean Patent Application No. 10-2021-θ177319, filed on Dec. 13, 2021, in the Korean Intellectual Property Office, the disclosure of which is incorporated by reference herein in its entirety.

### BACKGROUND

### 1. Field

The disclosure relates to a beam splitter using a multiple refractive index layer and a defective element detection device including the same, and more particularly, to a beam splitter using a multiple refractive index layer, which enables high magnification measurement by transmitting infrared light and reflecting visible light, and a defective element detection device including the same.

### 2. Description of the Related Art

In general, beam splitters suitable for splitting optical beams are used in many optical systems.

For example, in optical measurement systems, beam splitters are typically used to combine illumination and collection paths for use with a common lens.

However, when a spectrum of an optical beam of interest is wide, designing beam splitters for broadband applications that cover the wide spectrum presents several issues.

For example, in order to determine the positions or shapes of local micro hot spots, it is necessary to measure thermal images and real images by splitting visible light and infrared light emitted from the hot spots. In particular, the measurement of micro hot spots has to be performed at high magnification.

However, because a working distance of an infrared lens is short at high magnification, side optical observation is impossible when a conventional beam splitter that reflects infrared light and transmits visible light is used.

Therefore, there is a need for beam splitter technology for solving the above-mentioned defects.

### SUMMARY

The disclosure provides a beam splitter using a multiple refractive index layer, which enables high magnification measurement by transmitting infrared light and reflecting visible light, and a defective element detection device including the same.

The technical objectives to be achieved by the disclosure are not limited to the technical objectives described above, and other technical objectives that are not mentioned herein will be clearly understood by those of ordinary skill in the art from the following description.

Additional aspects will be set forth in part in the description which follows and, in part, will be apparent from the description, or may be learned by practice of the presented embodiments of the disclosure.

According to an embodiment, a beam splitter using a multiple refractive index layer includes a multiple refractive index layer configured to reflect first light and transmit second light having a wavelength longer than a wavelength of the first light, and a base layer provided on one side of the multiple refractive index layer and configured to transmit the second light transmitted through the multiple refractive index layer, wherein the multiple refractive index layer includes a first refractive index layer having a first refractive index and a second refractive index layer having a second refractive index less than the first refractive index, the first refractive index layer and the second refractive index layer are alternately and repeatedly arranged, and the wavelength of the second light is 10 times or more than the wavelength of the first light.

In an embodiment, a thickness of the first refractive index layer or a thickness of the second refractive index layer may be formed to be less than or equal to a length of the wavelength of the first light.

In an embodiment, incident light may be vertically incident on the multiple refractive index layer, and a thickness of the first refractive index layer or a thickness of the second refractive index layer may be calculated by a center wavelength of a reflection area of the first light, the first refractive index of the first refractive index layer, and the second refractive index of the second refractive index layer.

In an embodiment, the thickness of the first refractive index layer and the thickness of the second refractive index layer may be calculated by Equation (1) below, which includes the center wavelength of the reflection area of the first light.

$$λ1 = 2 \times ( n 1 \times d 1 + n 2 \times d 2 ) / na \qquad Equation ( 1 )$$

wherein λ1 is the center wavelength of the reflection area of the first light, n1 is the first refractive index of the first refractive index layer, d1 is the thickness of the first refractive index layer, n2 is the second refractive index of the second refractive index layer, d2 is the thickness of the second refractive index layer, and na is a natural number.

In an embodiment, an effective refractive index of the multiple refractive index layer may be less than a refractive index of the base layer, and the effective refractive index of the multiple refractive index layer may be calculated by Equation (2) below.

$${ne}^{2} = n {1}^{2} \times f 1 + n {2}^{2} \times f 2 \qquad Equation ( 2 )$$

wherein ne is the effective refractive index of the multiple refractive index layer, n1 is the first refractive index of the first refractive index layer, f1 is a ratio of the thickness of the first refractive index layer to a total thickness of the multiple refractive index layer, n2 is the second refractive index of the second refractive index layer, and f2 is a ratio of the thickness of the second refractive index layer to the total thickness of the multiple refractive index layer.

In an embodiment, a center wavelength of a transmission area of the second light transmitted through the multiple refractive index layer may be calculated by Equation (3) below.

$$dt = ( no \times λ2 ) / ( 4 \times ne ) \qquad Equation ( 3 )$$

wherein dt is the total thickness of the multiple refractive index layer, no is an odd number, λ2 is the center wavelength of the transmission area of the second light, and ne is the effective refractive index of the multiple refractive index layer.

In an embodiment, incident light may be obliquely incident on the multiple refractive index layer, and a thickness of the first refractive index layer or a thickness of the second refractive index layer may be calculated by a center wavelength of a reflection area of the first light, the first refractive index of the first refractive index layer, a refraction angle of the first refractive index layer, the second refractive index of the second refractive index layer, and a refraction angle the second refractive index layer.

In an embodiment, the thickness of the first refractive index layer and the thickness of the second refractive index layer may be calculated by Equation (4) below, which includes the center wavelength of the reflection area of the first light.

$$λ 1 = 2 \times ( n 1 \times d 1 \times cos θ1 + n 2 \times d 2 \times cos θ2 ) / na \qquad Equation ( 4 )$$

wherein λ1 is the center wavelength of the reflection area of the first light, n1 is the first refractive index of the first refractive index layer, d1 is the thickness of the first refractive index layer, θ1 is the refraction angle of the first refractive index layer, n2 is the second refractive index of the second refractive index layer, d2 is the thickness of the second refractive index layer, θ2 is the refraction angle of the second refractive index layer, and na is a natural number.

In an embodiment, an effective refractive index of the multiple refractive index layer may be less than a refractive index of the base layer, and the effective refractive index of the multiple refractive index layer may be calculated by Equation (5) below.

$${ne}^{2} = n {1}^{2} \times f 1 + n {2}^{2} \times f 2 \qquad Equation ( 5 )$$

wherein ne is the effective refractive index of the multiple refractive index layer, n1 is the first refractive index of the first refractive index layer, f1 is a ratio of the thickness of the first refractive index layer to a total thickness of the multiple refractive index layer, n2 is the second refractive index of the second refractive index layer, and f2 is a ratio of the thickness of the second refractive index layer to the total thickness of the multiple refractive index layer.

In an embodiment, a center wavelength of a transmission area of the second light transmitted through the multiple refractive index layer may be calculated by Equation (6) below.

$$dt = ( no \times λ 2 ) / ( 4 \times ne \times cos θ e ) \qquad Equation ( 6 )$$

wherein dt is the total thickness of the multiple refractive index layer, no is an odd number, λ2 is the center wavelength of the transmission area of the second light, ne is the effective refractive index of the multiple refractive index layer, and θe is an effective refraction angle of the multiple refractive index layer.

According to an embodiment, a beam splitter using a multiple refractive index layer includes a multiple refractive index layer configured to reflect first light and transmit second light having a wavelength longer than a wavelength of the first light, and a base layer provided on one side of the multiple refractive index layer and configured to transmit the second light transmitted through the multiple refractive index layer, wherein the multiple refractive index layer includes a first multiple refractive index layer including a first refractive index layer having a first refractive index and a second refractive index layer having a second refractive index less than the first refractive index, the first refractive index layer and the second refractive index layer being alternately and repeatedly arranged, the first multiple refractive index layer being configured to reflect an area including a first center wavelength from among reflection areas of the first light, and a second multiple refractive index layer including a third refractive index layer having a third refractive index and a fourth refractive index layer having a fourth refractive index less than the third refractive index, the third refractive index layer and the fourth refractive index layer being alternately and repeatedly arranged, the second multiple refractive index layer being configured to reflect an area including a second center wavelength that is different from the first center wavelength from among the reflection areas of the first light, and the wavelength of the second light is 10 times or more than the wavelength of the first light.

In an embodiment, incident light may be vertically incident on the multiple refractive index layer, a thickness of the first refractive index layer of the first multiple refractive index layer and a thickness of the second refractive index layer of the first multiple refractive index layer may be calculated by the first center wavelength of the reflection area of the first light, the first refractive index of the first refractive index layer, and the second refractive index of the second refractive index layer, and a thickness of the third refractive index layer of the second multiple refractive index layer and a thickness of the fourth refractive index layer of the second multiple refractive index layer may be calculated by the second center wavelength of the reflection area of the first light, the third refractive index of the third refractive index layer, and the fourth refractive index of the fourth refractive index layer.

In an embodiment, the thickness of the first refractive index layer of the first multiple refractive index layer and the thickness of the second refractive index layer of the first multiple refractive index layer may be calculated by Equation (7) below, which includes the first center wavelength of the reflection area of the first light.

$$λ 11 = 2 \times ( n 1 \times d 1 + n 2 \times d 2 ) / na \qquad Equation ( 7 )$$

wherein λ11 is the first center wavelength of the reflection area of the first light, n1 is the first refractive index of the first refractive index layer, d1 is the thickness of the first refractive index layer of the first multiple refractive index layer, n2 is the second refractive index of the second refractive index layer, d2 is the thickness of the second refractive index layer of the first multiple refractive index layer, and na is a natural number.
the thickness of the third refractive index layer of the second multiple refractive index layer and the thickness of the fourth refractive index layer of the second multiple refractive index layer may be calculated by Equation (8) below, which includes the second center wavelength of the reflection area of the first light.

$$λ 12 = 2 \times ( n 3 \times d 3 + n 4 \times d 4 ) / na \qquad Equation ( 8 )$$

wherein λ12 is the second center wavelength of the reflection area of the first light, n3 is the third refractive index of the third refractive index layer, d3 is the thickness of the third refractive index layer of the second multiple refractive index layer, n4 is the fourth refractive index of the fourth refractive index layer, d4 is the thickness of the fourth refractive index layer of the second multiple refractive index layer, and na is a natural number.

In an embodiment, an effective refractive index of the first multiple refractive index layer may be less than an effective refractive index of the second multiple refractive index layer, the effective refractive index of the second multiple refractive index layer may be less than a refractive index of the base layer, and the effective refractive index of the first multiple refractive index layer may be calculated by Equation (9) below.

$$ne {1}^{2} = n {1}^{2} \times f 11 + n {2}^{2} \times f 12 \qquad Equation ( 9 )$$

wherein ne1 is the effective refractive index of the first multiple refractive index layer, n1 is the first refractive index of the first refractive index layer, f11 is a ratio of the thickness of the first refractive index layer to a total thickness of the first multiple refractive index layer, n2 is the second refractive index of the second refractive index layer, and f12 is a ratio of the thickness of the second refractive index layer to the total thickness of the first multiple refractive index layer.

The effective refractive index of the second multiple refractive index layer may be calculated by Equation (10) below.

$$ne {2}^{2} = n {3}^{2} \times f 21 + n {4}^{2} \times f 22 \qquad Equation ( 10 )$$

wherein ne2 is the effective refractive index of the second multiple refractive index layer, n3 is the third refractive index of the third refractive index layer, f21 is a ratio of the thickness of the third refractive index layer to a total thickness of the second multiple refractive index layer, n4 is the fourth refractive index of the fourth refractive index layer, and f22 is a ratio of the thickness of the fourth refractive index layer to the total thickness of the second multiple refractive index layer.

In an embodiment, a first center wavelength of a transmission area of the second light transmitted through the first multiple refractive index layer may be calculated by Equation (11) below.

$$dt 1 = ( no \times λ 21 ) / ( 4 \times ne 1 ) \qquad Equation ( 11 )$$

wherein dt1 is the total thickness of the first multiple refractive index layer, no is an odd number, λ21 is the first center wavelength of the transmission area of the second light, and ne1 is the effective refractive index of the first multiple refractive index layer.

A second center wavelength of the transmission area of the second light transmitted through the second multiple refractive index layer may be calculated by Equation (12) below.

$$dt 2 = ( no \times λ 22 ) / ( 4 \times ne 2 ) \qquad Equation ( 12 )$$

wherein dt2 is the total thickness of the second multiple refractive index layer, no is an odd number, λ22 is the second center wavelength of the transmission area of the second light, and ne2 is the effective refractive index of the second multiple refractive index layer.

In an embodiment, incident light may be obliquely incident on the multiple refractive index layer, a thickness of the first refractive index layer of the first multiple refractive index layer and a thickness of the second refractive index layer of the first multiple refractive index layer may be calculated by the first center wavelength of the reflection area of the first light, the first refractive index of the first refractive index layer, a refraction angle of the first refractive index layer, the second refractive index of the second refractive index layer, and a refraction angle of the second refractive index layer, and a thickness of the third refractive index layer of the second multiple refractive index layer and a thickness of the fourth refractive index layer of the second multiple refractive index layer may be calculated by the second center wavelength of the reflection area of the first light, the third refractive index of the third refractive index layer, a refraction angle of the third refractive index layer, the fourth refractive index of the fourth refractive index layer, and a refraction angle of the fourth refractive index layer.

In an embodiment, the thickness of the first refractive index layer of the first multiple refractive index layer and the thickness of the second refractive index layer of the first multiple refractive index layer may be calculated by Equation (13) below, which includes the first center wavelength of the reflection area of the reflected first light.

$$λ 11 = 2 \times ( n 1 \times d 1 \times cos θ 1 + n 2 \times d 2 \times cos θ2 ) / na \qquad Equation ( 13 )$$

wherein λ11 is the first center wavelength of the reflection area of the first light, n1 is the first refractive index of the first refractive index layer, d1 is the thickness of the first refractive index layer of the first multiple refractive index layer, θ1 is the refraction angle of the first refractive index layer, n2 is the second refractive index of the second refractive index layer, d2 is the thickness of the second refractive index layer of the first multiple refractive index layer, θ2 is the refraction angle of the second refractive index layer, and na is a natural number.

The thickness of the third refractive index layer of the second multiple refractive index layer and the thickness of the fourth refractive index layer of the second multiple refractive index layer may be calculated by Equation (14) below, which includes the second center wavelength of the reflection area of the first light.

$$λ 12 = 2 \times ( n 3 \times d 3 \times cos θ 3 + n 4 \times d 4 \times cos θ4 ) / na \qquad Equation ( 14 )$$

wherein λ12 is the second center wavelength of the reflection area of the first light, n3 is the third refractive index of the third refractive index layer, d3 is the thickness of the third refractive index layer of the second multiple refractive index layer, θ3 is the refraction angle of the third refractive index layer, n4 is the fourth refractive index of the fourth refractive index layer, d4 is the thickness of the fourth refractive index layer of the second multiple refractive index layer, θ4 is the refraction angle of the fourth refractive index layer, and na is a natural number.

In an embodiment, an effective refractive index of the first multiple refractive index layer may be less than an effective refractive index of the second multiple refractive index layer, the effective refractive index of the second multiple refractive index layer may be less than a refractive index of the base layer, and the effective refractive index of the first multiple refractive index layer may be calculated by Equation (15) below.

$$ne {1}^{2} = n {1}^{2} \times f 11 + n {2}^{2} \times f 12 \qquad Equation ( 15 )$$

wherein ne1 is the effective refractive index of the first multiple refractive index layer, n1 is the first refractive index of the first refractive index layer, f11 is a ratio of the thickness of the first refractive index layer to a total thickness of the first multiple refractive index layer, n2 is the second refractive index of the second refractive index layer, and f12 is a ratio of the thickness of the second refractive index layer to the total thickness of the first multiple refractive index layer.

The effective refractive index of the second multiple refractive index layer may be calculated by Equation (16) below.

$$ne {2}^{2} = n {3}^{2} \times f 21 + n {4}^{2} \times f 22 \qquad Equation ( 16 )$$

wherein ne2 is the effective refractive index of the second multiple refractive index layer, n3 is the third refractive index of the third refractive index layer, f21 is a ratio of the thickness of the third refractive index layer to a total thickness of the second multiple refractive index layer, n4 is the fourth refractive index of the fourth refractive index layer, and f22 is a ratio of the thickness of the fourth refractive index layer to the total thickness of the second multiple refractive index layer.

In an embodiment, a first center wavelength of a transmission area of the second light transmitted through the first multiple refractive index layer may be calculated by Equation (17) below.

$$dt 1 = ( no \times λ 21 ) / ( 4 \times ne 1 \times cos θ e 1 ) \qquad Equation ( 17 )$$

wherein dt1 is the total thickness of the first multiple refractive index layer, no is an odd number, λ21 is the first center wavelength of the transmission area of the second light, ne1 is the effective refractive index of the first multiple refractive index layer, and θe1 is the effective refraction angle of the first multiple refractive index layer.

The second center wavelength of the transmission area of the second light transmitted through the second multiple refractive index layer may be calculated by Equation (18) below.

$$dt 2 = ( no \times λ 22 ) / ( 4 \times ne 2 \times cos θ e 2 ) \qquad Equation ( 18 )$$

wherein dt2 is the total thickness of the second multiple refractive index layer, no is an odd number, λ22 is the second center wavelength of the transmission area of the second light, ne2 is the effective refractive index of the second multiple refractive index layer, and θe2 is the effective refraction angle of the second multiple refractive index layer.

In an embodiment, the beam splitter may further include an anti-reflection layer provided on one side of the base layer and configured to prevent reflection of the second light transmitted through the multiple refractive index layer.

According to an embodiment, a defective element detection device includes the beam splitter using the multiple refractive index layer configured to reflect first light incident from an inspection target element and transmit second light having a wavelength longer than a wavelength of the first light incident from the inspection target element, a first image generator configured to generate first image information by receiving the first light reflected from the beam splitter using the multiple refractive index layer, a second image generator configured to generate second image information by receiving the second light transmitted through the beam splitter using the multiple refractive index layer, and a determiner configured to determine whether the inspection target element is defective, based on the first image information and the second image information.

In an embodiment, a length of a first optical path connecting the first image generator to the inspection target element may be formed to be greater than a length of a second optical path connecting the second image generator to the inspection target element.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a cross-sectional view illustrating a beam splitter using a multiple refractive index layer, according to an embodiment;

FIG. 2 is a graph showing visible light reflectivity of the beam splitter using the multiple refractive index layer of FIG. 1;

FIG. 3 is a graph showing infrared light transmissivity of the beam splitter using the multiple refractive index layer of FIG. 1;

FIG. 4 is a cross-sectional view illustrating another form of a beam splitter using a multiple refractive index layer, according to an embodiment;

FIGS. 5A and 5B are graphs showing visible light reflectivity and infrared light transmissivity of the beam splitter using the multiple refractive index layer of FIG. 4;

FIG. 6 is a cross-sectional view illustrating a beam splitter using a multiple refractive index layer, according to an embodiment;

FIG. 7 is an view illustrating light refraction when incident light is obliquely incident on the beam splitter using the multiple refractive index layer of FIG. 6;

FIGS. 8A and 8B are graphs showing visible light reflectivity and infrared light transmissivity when incident light is obliquely incident on the beam splitter using the multiple refractive index layer of FIG. 6;

FIG. 9 is a cross-sectional view illustrating a beam splitter using a multiple refractive index layer, according to another embodiment;

FIG. 10A to 10D are graphs showing visible light reflectivity of the beam splitter using the multiple refractive index layer of FIG. 9;

FIG. 11 is a graph showing infrared light transmissivity of the beam splitter using the multiple refractive index layer of FIG. 9;

FIG. 12 is a cross-sectional view illustrating a beam splitter using a multiple refractive index layer, according to another embodiment;

FIGS. 13A and 13B are graphs showing visible light reflectivity and infrared light transmissivity when incident light is obliquely incident on the beam splitter using the multiple refractive index layer of FIG. 12; and

FIG. 14 is an example view illustrating a defective element detection device according to an embodiment.

### DETAILED DESCRIPTION

Hereinafter, the disclosure will be described with reference to the accompanying drawings. However, the disclosure may be implemented in various different forms and is not limited to embodiments described herein. In order to clearly explain the disclosure, parts irrelevant to the description are omitted in the drawings and similar reference numerals denote similar parts throughout the specification.

It will be understood that when a portion is referred to as being “connected to (coupled to or in contact with)” another portion, it may be “directly connected to” the other portion or “indirectly connected to” the other portion with intervening portions therebetween. Throughout the disclosure, the expression “a portion includes a certain element” means that a portion further includes other elements rather than excludes other elements unless otherwise stated.

The terms as used herein are only used to describe particular embodiments and are not intended to limit the disclosure. The singular forms as used herein are intended to include the plural forms as well unless the context clearly indicates otherwise. The terms “comprise,” “include,” or “have” as used in the present specification are inclusive and therefore specify the presence of one or more stated features, integers, steps, operations, elements, components, or any combination thereof, but do not preclude the presence or addition of one or more other features, integers, steps, operations, elements, components, or any combination thereof.

Hereinafter, embodiments will be described in detail with reference to the accompanying drawings.

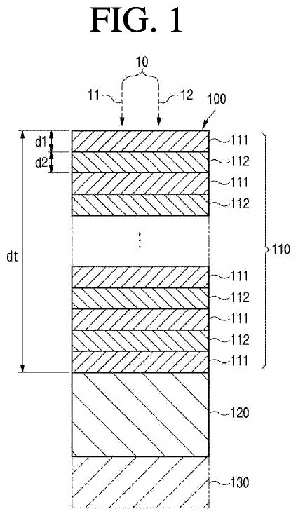

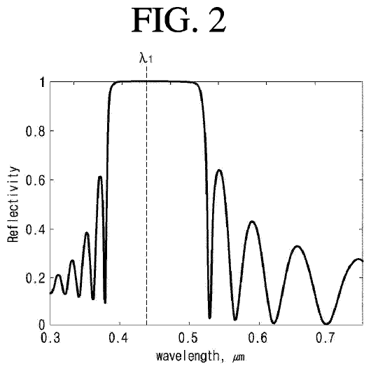

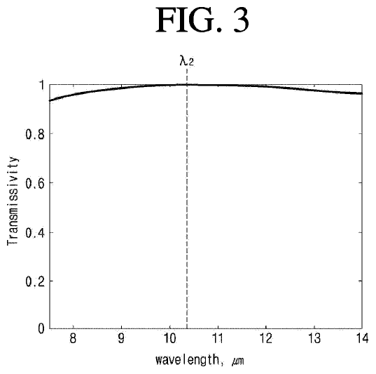

FIG. 1 is a cross-sectional view illustrating a beam splitter using a multiple refractive index layer, according to an embodiment, FIG. 2 is a graph showing visible light reflectivity of the beam splitter using the multiple refractive index layer of FIG. 1, and FIG. 3 is a graph showing infrared light transmissivity of the beam splitter using the multiple refractive index layer of FIG. 1.

As illustrated in FIGS. 1 to 3, a beam splitter 100 using a multiple refractive index layer may include a multiple refractive index layer 110 and a base layer 120.

Incident light 10 may be incident in a direction from the multiple refractive index layer 110 to the base layer 120.

The incident light 10 may include first light 11 and second light 12. The second light 12 is light having a wavelength longer than a wavelength of the first light 11. In particular, in the disclosure, the wavelength of the second light 12 is 10 times or more than the wavelength of the first light 11. The first light 11 may be visible light (about 0.4 μm to about 0.75 μm), and the second light 12 may be infrared light (about 7.5 μm to about 14 μm).

In the present embodiment, a case where the incident light 10 is vertically incident on the multiple refractive index layer 110 is described as an example.

The multiple refractive index layer 110 may include a first refractive index layer 111 having a first refractive index n1 and a second refractive index layer 112 having a second refractive index n2. The second refractive index n2 may be less than the first refractive index n1.

The first refractive index layer 111 may be formed of, for example, zinc sulfide (ZnS), and the second refractive index layer 112 may be formed of, for example, magnesium fluoride (MgF₂). A refractive index of zinc sulfide (ZnS) is 2.35 and a refractive index of magnesium fluoride (MgF₂) is 1.38.

A plurality of first refractive index layers 111 and a plurality of second refractive index layers 112 may be provided and may be alternately and repeatedly arranged. Accordingly, the multiple refractive index layer 110 may form a one-dimensional (1D) photonic crystal in which the first refractive index layers 111 and the second refractive index layers 112 are repeatedly arranged.

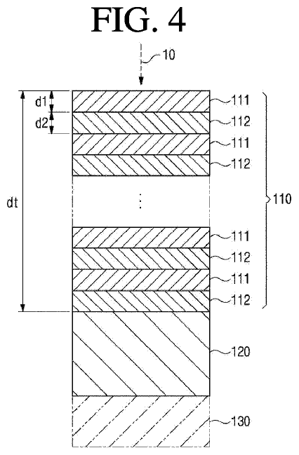

As illustrated in FIG. 1, the first refractive index layers 111 may be arranged on the uppermost and lowermost layers of the multiple refractive index layer 110, but the disclosure is not necessarily limited thereto. As illustrated in FIG. 4, when the first refractive index layer 111 is arranged on the uppermost layer of the multiple refractive index layer 110, the second refractive index layer 112 may be arranged on the lowermost layer of the multiple refractive index layer 110.

A thickness d1 of the first refractive index layer 111 or a thickness d2 of the second refractive index layer 112 may each be formed to be less than or equal to the wavelength of the first light 11. The thicknesses d1 of the first refractive index layers 111 are described as being equal to each other, but the disclosure is not limited thereto. Due to process errors or the like, the thicknesses of the first refractive index layers 111 may be different from each other. The thicknesses d2 of the second refractive index layers 112 may also be equal to each other, but the disclosure is not limited thereto. In some embodiments, the thicknesses d2 of the second refractive index layers 112 may be different from each other.

The multiple refractive index layer 110 may reflect the first light 11 and transmit the second light 12.

The base layer 120 may be provided on one side of the multiple refractive index layer 110, specifically, the back side of the multiple refractive index layer 110, and may transmit the second light 12 transmitted through the multiple refractive index layer 110. An effective refractive index of the multiple refractive index layer 110 may be less than a refractive index of the base layer 120.

The base layer 120 may be formed of, for example, zinc selenide (ZnSe). A refractive index of zinc selenide (ZnSe) is 2.58.

Specifically, when the first refractive index layer 111 and the second refractive index layer 112 are repeatedly stacked, a center wavelength of a reflection area of the first light 11 may be defined as Equation (1) below.

$$λ 1 = 2 \times ( n 1 \times d 1 + n 2 \times d 2 ) / na \qquad Equation ( 1 )$$

wherein λ1 is the center wavelength of the reflection area of the first light 11, n1 is the first refractive index of the first refractive index layer 111, d1 is the thickness of the first refractive index layer 111, n2 is the second refractive index of the second refractive index layer 112, d2 is the thickness of the second refractive index layer 112, and na is a natural number.

The first refractive index n1 may be given depending on the material of the first refractive index layer 111 and the second refractive index n2 may be given depending on the material of the second refractive index layer 112. The center wavelength λ1 of the reflection area of the first light 11 may be limited to a value within a range of about 0.4 μm to about 0.75 μm. Therefore, the thickness d1 of the first refractive index layer 111 and the thickness d2 of the second refractive index layer 112 may be calculated by Equation (1) above.

An effective medium theory may be applied because the wavelength of the second light 12 is greater than the thickness d1 of the first refractive index layer 111 and the thickness d2 of the second refractive index layer 112. That is, it may be assumed that the multiple refractive index layer 110 is a single layer having a thickness dt and an effective refractive index ne, and the effective refractive index ne of the multiple refractive index layer 110 may be calculated by Equation (2) below.

$${ne}^{2} = n {1}^{2} \times f 1 + n {2}^{2} \times f 2 \qquad Equation ( 2 )$$

wherein ne is the effective refractive index of the multiple refractive index layer 110, f1 is a ratio of the thickness d1 of the first refractive index layer 111 to the total thickness dt of the multiple refractive index layer 110, and f2 is a ratio of the thickness d2 of the second refractive index layer 112 to the total thickness dt of the multiple refractive index layer 110.

A center wavelength of a transmission area of the second light 12 transmitted through the multiple refractive index layer 110 may be calculated by Equation (3) below.

$$dt = ( no \times λ 2 ) / ( 4 \times ne ) \qquad Equation ( 3 )$$

wherein dt is the total thickness of the multiple refractive index layer 110, no is an odd number, and λ2 is the center wavelength of the transmission area of the second light 12.

The center wavelength λ2 of the transmission area of the second light 12 may be limited to a value within a range of about 7.5 μm to about 14 μm. Therefore, when the center wavelength of the transmission area of the second light 12, which is calculated by Equation (3), is within a range of about 7.5 μm to about 14 μm, the beam splitter 100 using the multiple refractive index layer may reflect the first light 11 of the incident light 10 and transmit the second light 12 of the incident light 10.

### First Embodiment

The first refractive index layer 111 is formed of zinc sulfide (ZnS) and the first refractive index n1 is 2.35. The second refractive index layer 112 is formed of magnesium fluoride (MgF₂) and the second refractive index n2 is 1.38.

In addition, the number of first refractive index layers 111 is 12 and the number of second refractive index layers 112 is 11, and thus, the multiple refractive index layer 110 is configured with a total of 23 layers.

The first light 11 is visible light (about 0.4 μm to about 0.75 μm). Therefore, the center wavelength λ1 of the reflection area of the first light 11 has to be within a range of about 0.4 μm to about 0.75 μm.

In Equation (1) above, regarding the thickness d1 of the first refractive index layer 111 and the thickness d2 of the second refractive index layer 112 so as to ensure that the center wavelength λ1 of the reflection area of the first light 11 is within a range of about 0.4 μm to about 0.75 μm, when the thickness d1 of the first refractive index layer 111 is 30 nm and the thickness d2 of the second refractive index layer 112 is 108 nm, λ1=2×(2.35×30 nm+1.38×108 nm)=439 nm. Because λ1 is within a range of about 0.4 μm to about 0.75 μm, λ1, d1, and d2 may be determined.

Referring to Equation (1) above, the center wavelength of the reflection area of the visible light 11 may be λ1, (λ1)/2, (λ1)/3, (λ1)/4, etc. When λ1 is 439 nm, the center wavelength of the reflection area of the visible light 11 may be within a range of about 0.4 μm to about 0.75 μm, but (1)/2 (=219.5 nm), (λ1)/3 (=146.3 nm), (λ1)/4 (=109.8 nm), etc. are not within a range of about 0.4 μm to about 0.75 μm. Therefore, only 439 nm is selected as λ1. Referring to FIG. 2, the beam splitter 100 using the multiple refractive index layer exhibits visible light reflection characteristics of 99.99% in a band with a center wavelength of 439 nm.

In some embodiments, because the number of first refractive index layers 111 is 12, the number of second refractive index layers 112 is 11, the thickness d1 of the first refractive index layer 111 is 30 nm, and the thickness d2 of the second refractive index layer 112 is 108 nm, the total thickness dt of the multiple refractive index layer 110 is 1,548 nm (=30 nm×12+108 nm×11).

Therefore, the ratio f1 of the thickness d1 of the first refractive index layer 111 to the total thickness dt of the multiple refractive index layer 110 is 0.232, and the ratio f2 of the thickness d2 of the second refractive index layer 112 to the total thickness dt of the multiple refractive index layer 110 is 0.767.

When the calculated values are applied to Equation (2) above, the effective refractive index ne of the multiple refractive index layer 110 is 1.657. In other words, it may be assumed that the multiple refractive index layer 110 is a material with a total thickness dt of 1,548 nm and an effective refractive index ne of 1.657.

The base layer 120 is formed of zinc selenide (ZnSe) and the refractive index of zinc selenide (ZnSe) is 2.58.

Because 1.657, which is the effective refractive index ne of the multiple refractive index layer 110, is less than 2.58, which is the refractive index of the base layer 120, the condition that the effective refractive index ne of the multiple refractive index layer 110 has to be less than the refractive index of the base layer 120 is satisfied.

When the calculated values are applied to Equation (3) above, the center wavelength of the reflection area of the second light 12 may be (¼)(λ2), (¾)(λ2), etc. However, the second light 12 is infrared light (about 7.5 μm to about 14 μm), and thus, the center wavelength of the reflection area of the second light 12 has to be within a range of about 7.5 μm to about 14 μm.

In the case of (¼)(λ2), the center wavelength λ2 of the transmission area of the second light 12 is 10,260 nm, which is within a range of about 7.5 μm to about 14 μm, but in the case of (¾)(λ2), the center wavelength λ2 is 3,420 nm, which is not within a range of about 7.5 μm to about 14 μm. Accordingly, 10,260 nm is selected as the center wavelength λ2 of the transmission area of the second light 12. Referring to FIG. 3, the beam splitter 100 using the multiple refractive index layer exhibits infrared light transmission characteristics of 98.2% in a band with a center wavelength of 10.26 μm.

In some embodiments, the beam splitter 100 using the multiple refractive index layer may further include an anti-reflection layer 130.

The anti-reflection layer 130 may be provided on one surface of the base layer 120. Specifically, the anti-reflection layer 130 may be provided on the back surface of the base layer 120. The anti-reflection layer 130 may prevent reflection of the second light 12 transmitted through the multiple refractive index layer 110. A material forming the anti-reflection layer 130 is not particularly limited as long as the material is capable of transmitting infrared light.

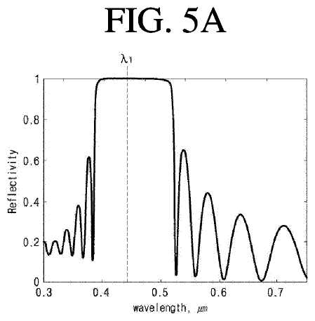

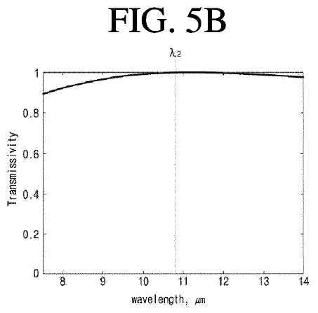

FIG. 4 is a cross-sectional view illustrating another form of a beam splitter using a multiple refractive index layer, according to an embodiment, and FIGS. 5A and 5B are graphs showing visible light reflectivity and infrared light transmissivity of the beam splitter using the multiple refractive index layer of FIG. 4.

As illustrated in FIGS. 4, 5A, and 5B, a first refractive index layer 111 may be arranged on the uppermost layer of a multiple refractive index layer 110 and a second refractive index layer 112 may be arranged on the lowermost layer of the multiple refractive index layer 110. The beam splitter using the multiple refractive index layer described with reference to FIGS. 4, 5A, and 5B may also reflect visible light and transmit infrared light with performance almost similar to the performance of the beam splitter 100 using the multiple refractive index layer described with reference to FIGS. 1 to 3.

### Second Embodiment

The first refractive index layer 111 is formed of zinc sulfide (ZnS), and the thickness d1 of the first refractive index layer 111 is 28 nm, and the first refractive index n1 is 2.35.

The second refractive index layer 112 is formed of magnesium fluoride (MgF₂), the thickness d2 of the second refractive index layer 112 is 112 nm, and the second refractive index n2 is 1.38.

In addition, the number of first refractive index layers 111 and the number of second refractive index layers 112 are each 12, and thus, the multiple refractive index layer 110 is configured with a total of 24 layers.

When these conditions are applied to Equation (1) above, λ1=440 nm (=2×(2.35×28 nm+1.38×112 nm)). The beam splitter using the multiple refractive index layer exhibits visible light reflection characteristics of 99.99% in a band with a center wavelength λ1 of 440 nm (see FIG. 5A).

In some embodiments, because the number of first refractive index layers 111 and second refractive index layers 112 are each 12 layers, the total thickness dt of the multiple refractive index layer 110 is 1,680 nm (=28 nm×12+112 nm×12).

Therefore, the ratio f1 of the thickness d1 of the first refractive index layer 111 to the total thickness dt of the multiple refractive index layer 110 is 0.2, and the ratio f2 of the thickness d2 of the second refractive index layer 112 to the total thickness dt of the multiple refractive index layer 110 is 0.8.

When the calculated values are applied to Equation (2) above, the effective refractive index ne of the multiple refractive index layer 110 is 1.621, which is less than the refractive index of the base layer 120 formed of zinc selenide (ZnSe), and thus, the condition is satisfied.

When the calculated values are applied to Equation (3) above, 10,880 nm, which is a value within a range of about 7.5 μm to about 14 μm, may be selected as the center wavelength λ2 of the transmission area of the second light.

Referring to FIG. 5B, the beam splitter using the multiple refractive index layer exhibits infrared light transmission characteristics of 97.8% in a band with a center wavelength of 10,880 μm.

A case where the incident light 10 is obliquely incident on the multiple refractive index layer is described below.

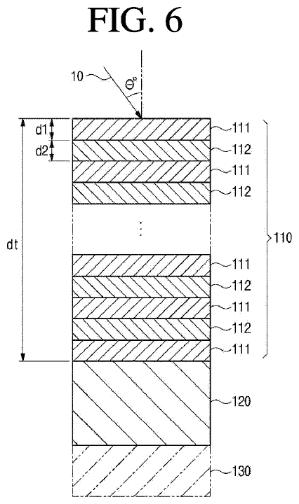

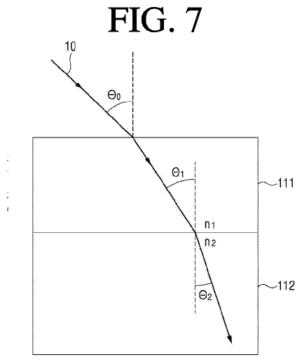

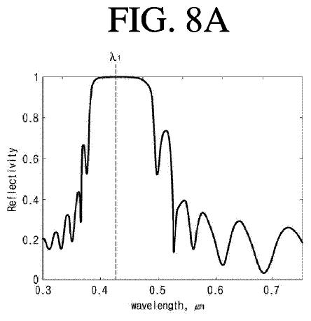

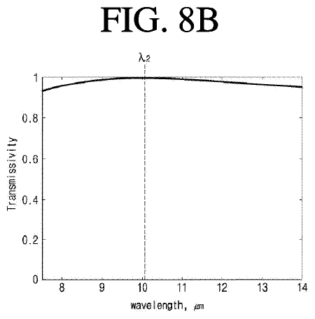

FIG. 6 is a cross-sectional view illustrating a beam splitter using a multiple refractive index layer, according to an embodiment, FIG. 7 is an view illustrating light refraction when incident light is obliquely incident on the beam splitter using the multiple refractive index layer of FIG. 6, and FIGS. 8A and 8B are graphs showing visible light reflectivity and infrared light transmissivity when incident light is obliquely incident on the beam splitter using the multiple refractive index layer of FIG. 6.

First, as illustrated in FIGS. 6 and 7, when incident light 10 is incident at an incidence angle θ0 tilted by a certain angle with respect to a virtual vertical axis, Relational Formula (1) of n0×sin θ0=n1×sin θ1=n2×sin θ2 is established in accordance with Snell's law.

In Relational Formula (1), no is a refractive index of air, n1 is a first refractive index of a first refractive index layer 111, n2 is a second refractive index of a second refractive index layer 112, θ1 is a refraction angle of the first refractive index layer 111, and θ2 is a refraction angle of the second refractive index layer 112.

When the incident light 10 is incident in air at an incidence angle of 45°, n0=1 and θ0=45°. When the calculated values are applied to Relational Formula (1), the first refractive index n1 of the first refractive index layer 111 is 2.35, and thus, the refraction angle θ1 of the first refractive index layer 111 is 17.5°. The second refractive index n2 of the second refractive index layer 112 is 1.38, and thus, the refraction angle θ2 of the second refractive index layer 112 is 30.8°.

### Third Embodiment

The first refractive index layer 111 is formed of zinc sulfide (ZnS), and the thickness d1 of the first refractive index layer 111 is 28 nm, and the first refractive index n1 of the first refractive index layer 111 is 2.35.

The second refractive index layer 112 is formed of magnesium fluoride (MgF₂), the thickness d2 of the second refractive index layer 112 is 127 nm, and the second refractive index n2 of the second refractive index layer 112 is 1.38.

In addition, the number of first refractive index layers 111 is 12 and the number of second refractive index layers 112 is 11, and thus, the multiple refractive index layer 110 is configured with a total of 23 layers.

Because the incident light 10 is incident in air at an angle of 45°, n0=1 and θ0=45°. According to Relational Formula (1), θ1=17.5° and θ2=30.8°.

The thickness d1 of the first refractive index layer 111 and the thickness d2 of the second refractive index layer 112 may be calculated by Equation (4) below, which includes the center wavelength λ1 of the reflection area of the visible light.

$$λ 1 = 2 \times ( n 1 \times d 1 \times cos θ 1 + n 2 \times d 2 \times cos θ 2 ) / na \qquad Equation ( 4 )$$

When the calculated values are applied to Equation (4) above, λ1=2×(2.35×28 nm×cos 17.5°+1.38×127) nm×cos 30.8°=426 nm. Referring to FIG. 8A, the beam splitter using the multiple refractive index layer exhibits visible light reflection characteristics of 99.99% in a band where the center wavelength of the reflection area of the visible light is 426 nm.

In addition, the base layer 120 is formed of zinc selenide (ZnSe) and the refractive index of the base layer 120 is 2.58.

Because the number of first refractive index layers 111 is 12 and the number of second refractive index layers 112 is 11, the total thickness dt of the multiple refractive index layer 110 is 1,733 nm (=28 nm×12+127 nm×11).

Therefore, the ratio f1 of the thickness d1 of the first refractive index layer 111 to the total thickness dt of the multiple refractive index layer 110 is 0.194, and the ratio f2 of the thickness d2 of the second refractive index layer 112 to the total thickness dt of the multiple refractive index layer 110 is 0.806.

The effective refractive index ne of the multiple refractive index layer 110 may be calculated by Equation (5) below.

$${ne}^{2} = n {1}^{2} \times f 1 + n {2}^{2} \times f 2 \qquad Equation ( 5 )$$

When the calculated values are applied to Equation (5) above, the effective refractive index ne of the multiple refractive index layer 110 is 1.614, which is less than the refractive index of the base layer 120, and thus, the condition is satisfied.

In addition, the center wavelength of the transmission area of the infrared light transmitted through the multiple refractive index layer 110 may be calculated by Equation (6) below.

$$dt = ( no \times λ 2 ) / ( 4 \times ne \times cos θ e ) \qquad Equation ( 6 )$$

wherein θe is the effective refraction angle of the multiple refractive index layer 110 and may be calculated by Relational Formula (2) of n0×sin θ0=ne×sin θe established by Snell's law. According to Relational Formula (2) above, θe=26°.

When the calculated effective refractive index ne and effective refraction angle θe of the multiple refractive index layer 110 are applied to Equation (6) above, the beam splitter using the multiple refractive index layer exhibits infrared light transmission characteristics of 97.5% in a band where the center wavelength λ2 of the transmission area of the infrared light is 10,050 nm (see FIG. 8B).

As such, the beam splitter 100 using the multiple refractive index layer, according to the disclosure, may implement excellent visible light reflection performance and excellent infrared light transmission performance when the incident light 10 is vertically incident on the multiple refractive index layer 110 or even when the incident light 10 is obliquely incident on the multiple refractive index layer 110.

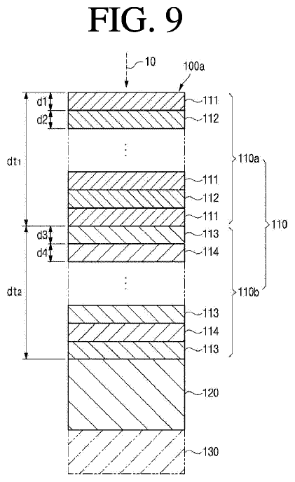

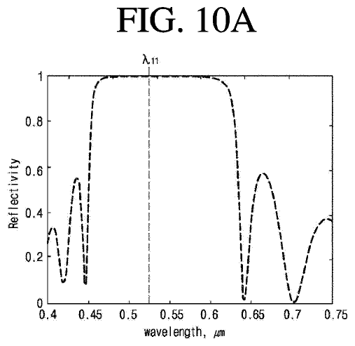

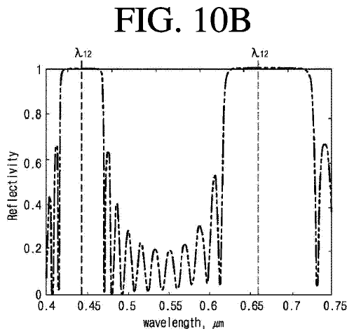

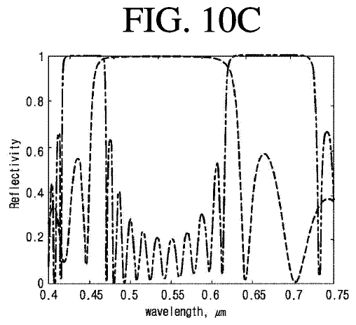

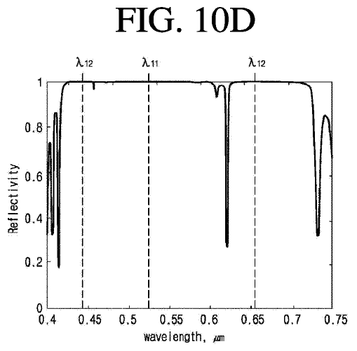

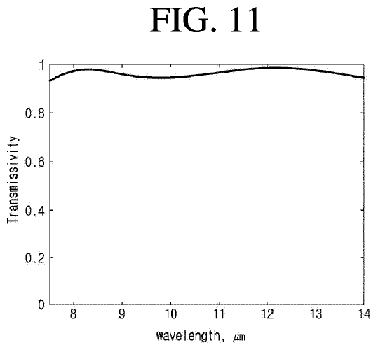

FIG. 9 is a cross-sectional view illustrating a beam splitter using a multiple refractive index layer, according to another embodiment, FIG. 10A to 10D are graphs showing visible light reflectivity of the beam splitter using the multiple refractive index layer of FIG. 9, and FIG. 11 is a graph showing infrared light transmissivity of the beam splitter using the multiple refractive index layer of FIG. 9. In the present embodiment, a plurality of multiple refractive index layers may be provided. Because other basic descriptions are the same as those of the above-described embodiments, repeated descriptions are omitted as much as possible.

As illustrated in FIGS. 9 to 11, a multiple refractive index layer 110 of a beam splitter 100a using a multiple refractive index layer, according to the present embodiment, may include a first multiple refractive index layer 110a and a second multiple refractive index layer 110b.

The first multiple refractive index layer 110a may include a first refractive index layer 111 having a first refractive index n1 and a second refractive index layer 112 having a second refractive index n2 less than the first refractive index n1. The first refractive index layer 111 and the second refractive index layer 112 are alternately and repeatedly arranged and may reflect an area including a first center wavelength λ11 from among reflection areas of visible light.

The second multiple refractive index layer 110b may include a third refractive index layer 113 having a third refractive index n3 and a fourth refractive index layer 114 having a fourth refractive index n4 less than the third refractive index n3. The third refractive index layer 113 and the fourth refractive index layer 114 are alternately and repeatedly arranged and may reflect an area including a second center wavelength λ12 different from the first center wavelength λ11 from among the reflection areas of visible light.

The third refractive index layer 113 may be formed of the same material as a material of the first refractive index layer 111. Accordingly, the third refractive index n3 may be equal to the first refractive index n1. In addition, the fourth refractive index layer 114 may be formed of the same material as a material of the second refractive index layer 112, and the fourth refractive index n4 may be equal to the second refractive index n2.

### Fourth Embodiment

Incident light 10 is vertically incident on the multiple refractive index layer 110.

The first refractive index n1 of the first refractive index layer 111 formed of zinc sulfide (ZnS) is 2.35, and the second refractive index n2 of the second refractive index layer 112 formed of magnesium fluoride (MgF₂) is 1.38. The refractive index of the base layer 120 formed of zinc selenide (ZnSe) is 2.58.

A thickness d1 of the first refractive index layer 111 of the first multiple refractive index layer 110a and a thickness d2 of the second refractive index layer 112 of the first multiple refractive index layer 110a may be calculated by Equation (7) below, which includes the first center wavelength of the reflection area of the visible light.

$$λ 11 = 2 \times ( n 1 \times d 1 + n 2 \times d 2 ) / na \qquad Equation ( 7 )$$

wherein λ11 is the first center wavelength of the reflection area of the visible light.

When the first center wavelength λ11 of the reflection area of the visible light, the thickness d1 of the first refractive index layer 111, and the thickness d2 of the second refractive index layer 112 are calculated from Equation (7) above, λ11=523 nm (=2×(2.35×38 nm+1.38×115 nm)) when the thickness d1 of the first refractive index layer 111 is 38 nm and the thickness d2 of the second refractive index layer 112 is 125 nm. Thus, the condition is satisfied. That is, the first multiple refractive index layer 110a exhibits visible light reflection characteristics of 99.99% in a band where the first center wavelength λ11 of the reflection area of the visible light is 523 nm (see FIG. 10A).

The thickness d3 of the third refractive index layer 113 of the second multiple refractive index layer 110b and the thickness d4 of the fourth refractive index layer 114 of the second multiple refractive index layer 110b may be calculated by Equation (8) below, which includes the second center wavelength of the reflection area of the visible light.

$$λ 12 = 2 \times ( n 3 \times d 3 + n 4 \times d 4 ) / na \qquad Equation ( 8 )$$

wherein λ12 is the second center wavelength of the reflection area of the visible light.

When the second center wavelength λ12 of the reflection area of the visible light, the thickness d3 of the third refractive index layer 113, and the thickness d4 of the fourth refractive index layer 114 are calculated from Equation (8) above, λ12=1,325 nm (=2×(2.35×232 nm+1.38×85 nm)) when the thickness d3 of the third refractive index layer 113 is 232 nm and the thickness d4 of the fourth refractive index layer 114 is 85 nm.

1,325 nm is not within a range of visible light (about 0.4 μm to about 0.75 μm), but (λ12)/2 (=662.5 nm) and (λ12)/3 (=441.6 nm) are within a range of about 0.4 μm to about 0.75 μm. Thus, the condition is satisfied.

The second multiple refractive index layer 110b exhibits visible light reflection characteristics of 99.99% in a band where the second center wavelength λ12 of the reflection area of the visible light is 441.6 nm and 662.5 nm.

The visible light reflection characteristics of the first multiple refractive index layer 110a and the visible light reflection characteristics of the second multiple refractive index layer 110b may be implemented by overlapping each other (see FIG. 10C).

Therefore, the beam splitter 100a using the multiple refractive index layer, according to the present embodiment, may exhibit visible light reflection characteristics of 99.99% in a bands where the center wavelengths of the reflection area of the visible light are 523 nm, 441.6 nm, and 662.5 nm, and excellent reflection characteristics may be implemented in almost the entire area of the visible light (see FIG. 10D).

In some embodiments, the number of first refractive index layers 111 is 10 and the number of second refractive index layers 112 is 9, and thus, the first multiple refractive index layer 110a is configured with a total of 19 layers.

The effective refractive index of the first multiple refractive index layer 110a may be calculated by Equation (9) below.

$$ne {1}^{2} = n {1}^{2} \times f 11 + n {2}^{2} \times f 12 \qquad Equation ( 9 )$$

wherein ne1 is the effective refractive index of the first multiple refractive index layer 110a, f11 is a ratio of the thickness d1 of the first refractive index layer 111 to the total thickness dt1 of the first multiple refractive index layer 110a, and f12 is a ratio of the thickness d2 of the second refractive index layer 112 to the total thickness dt1 of the first multiple refractive index layer 110a.

Accordingly, the total thickness dt1 of the first multiple refractive index layer 110a is 1,505 nm.

In addition, the ratio f11 of the thickness d1 of the first refractive index layer 111 to the total thickness dt1 of the first multiple refractive index layer 110a is 0.252, and the ratio f12 of the thickness d2 of the second refractive index layer 112 to the total thickness dt1 of the first multiple refractive index layer 110a is 0.748.

When the calculated values are applied to Equation (9) above, the effective refractive index ne1 of the first multiple refractive index layer 110a is 1.678. The condition is satisfied because the effective refractive index ne1 of the first multiple refractive index layer 110a is less than the refractive index of the base layer 120.

In some embodiments, the effective refractive index of the second multiple refractive index layer 110b may be calculated by Equation (10) below.

$$ne {2}^{2} = n {3}^{2} \times f 21 + n {4}^{2} \times f 22 \qquad Equation ( 10 )$$

wherein ne2 is the effective refractive index of the second multiple refractive index layer 110b, f21 is a ratio of the thickness d3 of the third refractive index layer 113 to the total thickness dt2 of the second multiple refractive index layer 110b, and f22 is a ratio of the thickness d4 of the fourth refractive index layer 114 to the total thickness dt2 of the second multiple refractive index layer 110b.

Accordingly, the total thickness dt2 of the second multiple refractive index layer 110b is 3,402 nm.

In addition, the ratio f21 of the thickness d3 of the third refractive index layer 113 to the total thickness dt2 of the second multiple refractive index layer 110b is 0.750, and the ratio f22 of the thickness d4 of the fourth refractive index layer 114 to the total thickness dt2 of the second multiple refractive index layer 110b is 0.250.

When the calculated values are applied to Equation (10) above, the effective refractive index ne2 of the second multiple refractive index layer 110b is 2.149. The condition is satisfied because the effective refractive index ne2 of the second multiple refractive index layer 110b is greater than the effective refractive index ne1 of the first multiple refractive index layer 110a and less than the refractive index of the base layer 120.

In addition, the first center wavelength of the transmission area of the infrared light transmitted through the first multiple refractive index layer 110a may be calculated by Equation (11) below.

$$dt 1 = ( no \times λ 21 ) / ( 4 \times ne 1 ) \qquad Equation ( 11 )$$

wherein λ21 is the first center wavelength of the transmission area of the infrared light.

In addition, the second center wavelength of the transmission area of the infrared light transmitted through the second multiple refractive index layer 110b may be calculated by Equation (12) below.

$$dt 2 = ( no \times λ 22 ) / ( 4 \times ne 2 ) \qquad Equation ( 12 )$$

wherein λ22 is the second center wavelength of the transmission area of the infrared light.

When the calculated values are applied to Equations (11) and (12) above, the first center wavelength λ21 of the transmission area of the infrared light transmitted through the first multiple refractive index layer 110a is 10,101 nm, and the second center wavelength λ22 of the transmission area of the infrared light transmitted through the second multiple refractive index layer 110b is 9,750 nm.

The infrared light transmission characteristics of the first multiple refractive index layer 110a and the infrared light transmission characteristics of the second multiple refractive index layer 110b may also be implemented by overlapping each other. Therefore, the beam splitter using the multiple refractive index layer, according to the present embodiment, may exhibit infrared light transmission characteristics of 96.6% in a band where the center wavelength of the transmission area of the infrared light is 9.75 μm and 10.1 μm, and excellent transmission characteristics may be implemented in almost the entire area of the infrared light.

A case where the incident light 10 is obliquely incident on the multiple refractive index layer is described below.

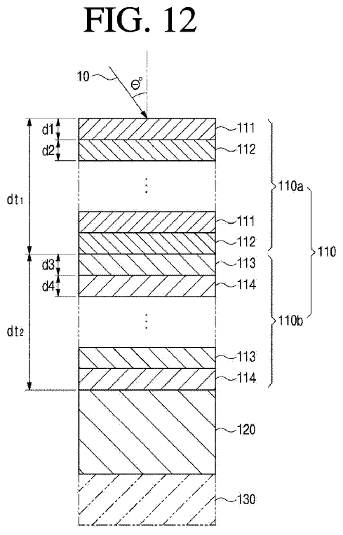

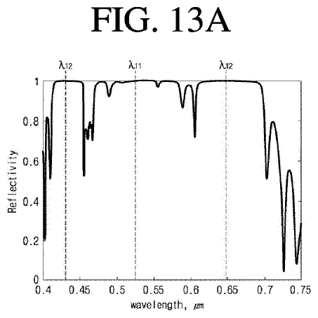

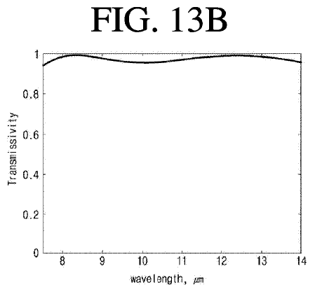

FIG. 12 is a cross-sectional view illustrating a beam splitter using a multiple refractive index layer, according to another embodiment, and FIGS. 13A and 13B are graphs showing visible light reflectivity and infrared light transmissivity when incident light is obliquely incident on the beam splitter using the multiple refractive index layer of FIG. 12. The following description is given with reference to FIGS. 12, 13A, and 13B.

### Fifth Embodiment

Incident light 10 is obliquely incident on a multiple refractive index layer 110.

A first refractive index layer 111 and a third refractive index layer 113 are each formed of zinc sulfide (ZnS), and a first refractive index n1 of the first refractive index layer 111 and a third refractive index n3 of the third refractive index layer 113 are each 2.35.

A second refractive index layer 112 and a fourth refractive index layer 114 are each formed of magnesium fluoride (MgF₂), and a second refractive index n2 of the second refractive index layer 112 and a fourth refractive index n4 of the fourth refractive index layer 114 are each 1.38.

A refractive index of a base layer 120 formed of zinc selenide (ZnSe) is 2.58.

Because the incident light 10 is incident in air at 45°, n0=1 and θ0=45°. Because the first refractive index n1 of the first refractive index layer 111 is 2.35, θ1 is 17.5°. Because the second refractive index n2 of the second refractive index layer 112 is 1.38, θ2=30.8°.

A thickness d1 of the first refractive index layer 111 of the first multiple refractive index layer 110a and a thickness d2 of the second refractive index layer 112 of the first multiple refractive index layer 110a may be calculated by Equation (13) below, which includes a first center wavelength λ11 of a reflection area of the reflected visible light.

$$λ 11 = 2 \times ( n 1 \times d 1 \times cos θ 1 + n 2 \times d 2 \times cos θ 2 ) / na \qquad Equation ( 13 )$$

When the first center wavelength λ11 of the reflection area of the visible light, the thickness d1 of the first refractive index layer 111, and the thickness d2 of the second refractive index layer 112 are calculated from Equation (13) above, ×11=2×(2.35×33 nm×cos 17.5°+1.38×159) nm×cos 30.8°=525 nm when the thickness d1 of the first refractive index layer 111 is 33 nm and the thickness d2 of the second refractive index layer 112 is 159 nm.

A thickness d3 of the third refractive index layer 113 of the second multiple refractive index layer 110b and a thickness d4 of the fourth refractive index layer 114 of the second multiple refractive index layer 110b may be calculated by Equation (14) below, which includes a second center wavelength of the reflection area of the reflected visible light.

$$λ 12 = 2 \times ( n 3 \times d 3 \times cos θ 3 + n 4 \times d 4 \times cos θ 4 ) / na \qquad Equation ( 14 )$$

When the second center wavelength λ12 of the reflection area of the visible light, the thickness d3 of the third refractive index layer 113, and the thickness d4 of the fourth refractive index layer 114 are calculated from Equation (14) above, ×12=2×(2.35×236 nm×cos 17.5°+1.38×101 nm×cos 30.8°)=1,297 nm when the thickness d3 of the third refractive index layer 113 is 236 nm and the thickness d4 of the fourth refractive index layer 114 is 101 nm.

1,297 nm is not within a range of visible light (about 0.4 μm to about 0.75 μm), but (λ12)/2 (=648 nm) and (λ12)/3 (=432 nm) are within a range of about 0.4 μm to about 0.75 μm. Thus, the condition is satisfied.

The second multiple refractive index layer 110b exhibits visible light reflection characteristics of 99.9% in a band where the second center wavelength λ12 of the reflection area of the visible light is 432 nm and 648 nm.

Accordingly, the beam splitter using the multiple refractive index layer, according to the present embodiment, may implement excellent reflection characteristics in most areas of the visible light through bands where the center wavelengths of the reflection areas of the visible light are 432 nm, 525 nm, and 648 nm.

The number of first refractive index layers 111 and the number of second refractive index layers 112 are each 9, and thus, the multiple refractive index layer 110a is configured with a total of 18 layers.

An effective refractive index ne1 of the first multiple refractive index layer 110a may be calculated by Equation (15) below.

$$ne {1}^{2} = n {1}^{2} \times f 11 + n {2}^{2} \times f 12 \qquad Equation ( 15 )$$

wherein f11 is a ratio of the thickness d1 of the first refractive index layer 111 to a total thickness dt1 of the first multiple refractive index layer 110a, and f12 is a ratio of the thickness d2 of the second refractive index layer 112 to the total thickness dt1 of the first multiple refractive index layer 110a.

The total thickness dt1 of the first multiple refractive index layer 110a is 1,728 nm.

In addition, the ratio f11 of the thickness d1 of the first refractive index layer 111 to the total thickness dt1 of the first multiple refractive index layer 110a is 0.172, and the ratio f12 of the thickness d2 of the second refractive index layer 112 to the total thickness dt1 of the first multiple refractive index layer 110a is 0.828.

When the calculated values are applied to Equation (15) above, the effective refractive index ne1 of the first multiple refractive index layer 110a is 1.589.

An effective refractive index ne2 of the second multiple refractive index layer 110b may be calculated by Equation (16) below.

$$ne {2}^{2} = n {3}^{2} \times f 21 + n {4}^{2} \times f 22 \qquad Equation ( 16 )$$

wherein f21 is a ratio of the thickness d3 of the third refractive index layer 113 to a total thickness dt2 of the second multiple refractive index layer 110b, and f22 is a ratio of the thickness d4 of the fourth refractive index layer 114 to the total thickness dt2 of the second multiple refractive index layer 110b.

The total thickness dt2 of the second multiple refractive index layer 110b is 3,707 nm.

In addition, the ratio f21 of the thickness d3 of the third refractive index layer 113 to the total thickness dt2 of the second multiple refractive index layer 110b is 0.700, and the ratio f22 of the thickness d4 of the fourth refractive index layer 114 to the total thickness dt2 of the second multiple refractive index layer 110b is 0.300.

When the calculated values are applied to Equation (16) above, the effective refractive index ne2 of the second multiple refractive index layer 110b is 2.107.

The effective refractive index ne1 of the first multiple refractive index layer 110a is less than the effective refractive index ne2 of the second multiple refractive index layer 110b, and the effective refractive index ne2 of the second multiple refractive index layer 110b is less than the refractive index of the base layer 120. Thus, the refractive index condition is satisfied.

The first center wavelength λ21 of the transmission area of the infrared light transmitted through the first multiple refractive index layer 110a may be calculated by Equation (17) below.

$$dt 1 = ( no \times λ21 ) / ( 4 \times ne 1 \times cos θ e 1 ) \qquad Equation ( 17 )$$

wherein θe1 is an effective refraction angle of the first multiple refractive index layer 110a. According to Relational Formula (2), θe1=26.4°.

In addition, the second center wavelength λ22 of the transmission area of the infrared light transmitted through the second multiple refractive index layer 110b may be calculated by Equation (18) below.

$$dt 2 = ( no \times λ22 ) / ( 4 \times ne 2 \times cos θ e 2 ) \qquad Equation ( 18 )$$

wherein θe2 is an effective refraction angle of the second multiple refractive index layer 110b. According to Relational Formula (2), θe2=19.6°.

When the calculated values are applied to Equations (17) and (18) above, the first center wavelength λ21 of the transmission area of the infrared light transmitted through the first multiple refractive index layer 110a is 9,840 nm, and the second center wavelength λ22 of the transmission area of the infrared light transmitted through the second multiple refractive index layer 110b is 9,810 nm.

Therefore, the beam splitter using the multiple refractive index layer, according to the present embodiment, may implement excellent transmission characteristics in most areas of the infrared light through bands where the center wavelengths of the transmission areas of the infrared light are 9.84 μm and 9.81 μm.

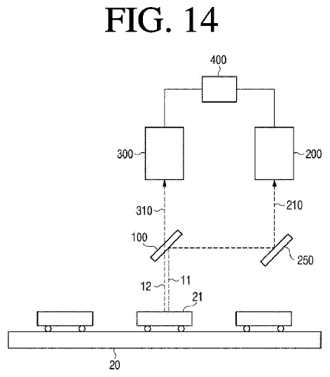

FIG. 14 is an example view illustrating a defective element detection device according to an embodiment.

As illustrated in FIG. 14, the defective element detection device may include a beam splitter 100 using a multiple refractive index layer, a first image generator 200, a second image generator 300, and a determiner 400.

The beam splitter 100 using the multiple refractive index layer may be the beam splitter using the multiple refractive index layer described above.

The beam splitter 100 using the multiple refractive index layer may be provided vertically upward from an inspection target element 21 from among elements on a substrate 20. The beam splitter 100 using the multiple refractive index layer may reflect first light 11 incident from the inspection target element 21 and transmit second light 12 incident from the inspection target element 21.

The first image generator 200 may generate first image information by receiving the first light 11 reflected from the beam splitter 100 using the multiple refractive index layer. The first light 11 may be visible light and the first image information may be a real image.

The second image generator 300 may generate second image information by receiving the second light 12 transmitted through the beam splitter 100 using the multiple refractive index layer. The second light 12 may be infrared light and the second image information may be a thermal image.

The second image generator 300 may be provided vertically upward from the beam splitter 100 using the multiple refractive index layer and may directly receive the second light 12 transmitted through the beam splitter 100 using the multiple refractive index layer.

Accordingly, the length of a second optical path 310 connecting the second image generator 300 to the inspection target element 21 may be reduced. In other words, a working distance of infrared light may be reduced, which enables high-magnification measurement.

A mirror 250 may be further provided between the first image generator 200 and the beam splitter 100 using the multiple refractive index layer. The mirror 250 may guide the first light 11 reflected from the beam splitter 100 using the multiple refractive index layer to the first image generator 200. Accordingly, the length of a first optical path 210 connecting the first image generator 200 to the inspection target element 21 may be formed to be greater than the length of the second optical path 310.

The determiner 400 may determine whether the inspection target element 21 is defective, based on the first image information and the second image information.

The foregoing description of the disclosure is for illustrative purposes only, and those of ordinary skill in the art to which the disclosure pertains will understand that modifications into other specific forms may be made thereto without changing the technical spirit or essential features of the disclosure. Therefore, it should be understood that the embodiments described above are illustrative in all aspects and are not restrictive. For example, the components described as being singular may be implemented in a distributed manner. Similarly, the components described as being distributed may be implemented in a combined form.

The scope of the disclosure is defined by the appended claims, and all changes or modifications derived from the meaning and scope of the claims and equivalent concepts thereof should be construed as falling within the scope of the disclosure. According to embodiments, the beam splitter using the multiple refractive index layer may implement excellent visible light reflection performance and excellent infrared light transmission performance even when incident light is vertically or obliquely incident on the multiple refractive index layer.

In addition, according to embodiments, in the defective element detection device, the working distance of infrared light be reduced by using the beam splitter using the multiple refractive index layer, which enables high-magnification measurement.

The effects of the disclosure are not limited to the above-described effects, but should be understood to include all effects that may be inferred from the configurations of the disclosure set forth in the detailed description or the claims of the disclosure.

1. A beam splitter using a multiple refractive index layer, the beam splitter comprising:
a multiple refractive index layer configured to reflect first light and transmit second light having a wavelength longer than a wavelength of the first light; and
a base layer provided on one side of the multiple refractive index layer and configured to transmit the second light transmitted through the multiple refractive index layer,
wherein the multiple refractive index layer comprises a first refractive index layer having a first refractive index and a second refractive index layer having a second refractive index less than the first refractive index,
the first refractive index layer and the second refractive index layer are alternately and repeatedly arranged, and
the wavelength of the second light is 10 times or more than the wavelength of the first light.

2. The beam splitter of claim 1, wherein a thickness of the first refractive index layer or a thickness of the second refractive index layer is formed to be less than or equal to a length of the wavelength of the first light.

3. The beam splitter of claim 1, wherein incident light is vertically incident on the multiple refractive index layer, and
a thickness of the first refractive index layer or a thickness of the second refractive index layer is calculated by a center wavelength of a reflection area of the first light, the first refractive index of the first refractive index layer, and the second refractive index of the second refractive index layer.

4. The beam splitter of claim 3, wherein the thickness of the first refractive index layer and the thickness of the second refractive index layer are calculated by Equation (1) below, which includes the center wavelength of the reflection area of the first light:
$$λ1 = 2 \times ( n 1 \times d 1 + n 2 \times d 2 ) / na \qquad Equation ( 1 )$$
wherein λ1 is the center wavelength of the reflection area of the first light, n1 is the first refractive index of the first refractive index layer, d1 is the thickness of the first refractive index layer, n2 is the second refractive index of the second refractive index layer, d2 is the thickness of the second refractive index layer, and na is a natural number.

5. The beam splitter of claim 4, wherein an effective refractive index of the multiple refractive index layer is less than a refractive index of the base layer, and
the effective refractive index of the multiple refractive index layer is calculated by Equation (2) below:
$${ne}^{2} = n {1}^{2} \times f 1 + n {2}^{2} \times f 2 \qquad Equation ( 2 )$$
wherein ne is the effective refractive index of the multiple refractive index layer, n1 is the first refractive index of the first refractive index layer, f1 is a ratio of the thickness of the first refractive index layer to a total thickness of the multiple refractive index layer, n2 is the second refractive index of the second refractive index layer, and f2 is a ratio of the thickness of the second refractive index layer to the total thickness of the multiple refractive index layer.

6. The beam splitter of claim 5, wherein a center wavelength of a transmission area of the second light transmitted through the multiple refractive index layer is calculated by Equation (3) below:
$$dt = ( no \times λ2 ) / ( 4 \times ne ) \qquad Equation ( 3 )$$
wherein dt is the total thickness of the multiple refractive index layer, no is an odd number, λ2 is the center wavelength of the transmission area of the second light, and ne is the effective refractive index of the multiple refractive index layer.

7. The beam splitter of claim 1, wherein incident light is obliquely incident on the multiple refractive index layer, and
a thickness of the first refractive index layer or a thickness of the second refractive index layer is calculated by a center wavelength of a reflection area of the first light, the first refractive index of the first refractive index layer, a refraction angle of the first refractive index layer, the second refractive index of the second refractive index layer, and a refraction angle the second refractive index layer.

8. The beam splitter of claim 7, wherein the thickness of the first refractive index layer and the thickness of the second refractive index layer are calculated by Equation (4) below, which includes the center wavelength of the reflection area of the first light:
$$λ1 = 2 \times ( n 1 \times d 1 \times cos θ1 + n 2 \times d 2 \times cos θ2 ) / na \qquad Equation ( 4 )$$
wherein λ1 is the center wavelength of the reflection area of the first light, n1 is the first refractive index of the first refractive index layer, d1 is the thickness of the first refractive index layer, θ1 is the refraction angle of the first refractive index layer, n2 is the second refractive index of the second refractive index layer, d2 is the thickness of the second refractive index layer, θ2 is the refraction angle of the second refractive index layer, and na is a natural number.

9. The beam splitter of claim 8, wherein an effective refractive index of the multiple refractive index layer is less than a refractive index of the base layer, and
the effective refractive index of the multiple refractive index layer is calculated by Equation (5) below:
$${ne}^{2} = n {1}^{2} \times f 1 + n {2}^{2} \times f 2 \qquad Equation ( 5 )$$
wherein ne is the effective refractive index of the multiple refractive index layer, n1 is the first refractive index of the first refractive index layer, f1 is a ratio of the thickness of the first refractive index layer to a total thickness of the multiple refractive index layer, n2 is the second refractive index of the second refractive index layer, and f2 is a ratio of the thickness of the second refractive index layer to the total thickness of the multiple refractive index layer.

10. The beam splitter of claim 9, wherein a center wavelength of a transmission area of the second light transmitted through the multiple refractive index layer is calculated by Equation (6) below:
$$dt = ( no \times λ2 ) / ( 4 \times ne \times cos θ e ) \qquad Equation ( 6 )$$
wherein dt is the total thickness of the multiple refractive index layer, no is an odd number, λ2 is the center wavelength of the transmission area of the second light, ne is the effective refractive index of the multiple refractive index layer, and θe is an effective refraction angle of the multiple refractive index layer.

11. A beam splitter using a multiple refractive index layer, the beam splitter comprising:
a multiple refractive index layer configured to reflect first light and transmit second light having a wavelength longer than a wavelength of the first light; and
a base layer provided on one side of the multiple refractive index layer and configured to transmit the second light transmitted through the multiple refractive index layer,
wherein the multiple refractive index layer comprises:
a first multiple refractive index layer comprising a first refractive index layer having a first refractive index and a second refractive index layer having a second refractive index less than the first refractive index, the first refractive index layer and the second refractive index layer being alternately and repeatedly arranged, the first multiple refractive index layer being configured to reflect an area including a first center wavelength from among reflection areas of the first light; and
a second multiple refractive index layer comprising a third refractive index layer having a third refractive index and a fourth refractive index layer having a fourth refractive index less than the third refractive index, the third refractive index layer and the fourth refractive index layer being alternately and repeatedly arranged, the second multiple refractive index layer being configured to reflect an area including a second center wavelength that is different from the first center wavelength from among the reflection areas of the first light, and
the wavelength of the second light is 10 times or more than the wavelength of the first light.

12-15. (canceled)

16. The beam splitter of claim 11, wherein incident light is obliquely incident on the multiple refractive index layer,
a thickness of the first refractive index layer of the first multiple refractive index layer and a thickness of the second refractive index layer of the first multiple refractive index layer are calculated by the first center wavelength of the reflection area of the first light, the first refractive index of the first refractive index layer, a refraction angle of the first refractive index layer, the second refractive index of the second refractive index layer, and a refraction angle of the second refractive index layer, and
a thickness of the third refractive index layer of the second multiple refractive index layer and a thickness of the fourth refractive index layer of the second multiple refractive index layer are calculated by the second center wavelength of the reflection area of the first light, the third refractive index of the third refractive index layer, a refraction angle of the third refractive index layer, the fourth refractive index of the fourth refractive index layer, and a refraction angle of the fourth refractive index layer.

17. The beam splitter of claim 16, wherein the thickness of the first refractive index layer of the first multiple refractive index layer and the thickness of the second refractive index layer of the first multiple refractive index layer are calculated by Equation (13) below, which includes the first center wavelength of the reflection area of the reflected first light:
$$λ11 = 2 \times ( n 1 \times d 1 \times cos θ1 + n 2 \times d 2 \times cos θ2 ) / na \qquad Equation ( 13 )$$
wherein λ11 is the first center wavelength of the reflection area of the first light, n1 is the first refractive index of the first refractive index layer, d1 is the thickness of the first refractive index layer of the first multiple refractive index layer, θ1 is the refraction angle of the first refractive index layer, n2 is the second refractive index of the second refractive index layer, d2 is the thickness of the second refractive index layer of the first multiple refractive index layer, θ2 is the refraction angle of the second refractive index layer, and na is a natural number, and
the thickness of the third refractive index layer of the second multiple refractive index layer and the thickness of the fourth refractive index layer of the second multiple refractive index layer are calculated by Equation (14) below, which includes the second center wavelength of the reflection area of the first light:
$$λ12 = 2 \times ( n 3 \times d 3 \times cos θ3 + n 4 \times d 4 \times cos θ4 ) / na \qquad Equation ( 14 )$$
wherein λ12 is the second center wavelength of the reflection area of the first light, n3 is the third refractive index of the third refractive index layer, d3 is the thickness of the third refractive index layer of the second multiple refractive index layer, θ3 is the refraction angle of the third refractive index layer, n4 is the fourth refractive index of the fourth refractive index layer, d4 is the thickness of the fourth refractive index layer of the second multiple refractive index layer, θ4 is the refraction angle of the fourth refractive index layer, and na is a natural number.

18. The beam splitter of claim 17, wherein an effective refractive index of the first multiple refractive index layer is less than an effective refractive index of the second multiple refractive index layer,
the effective refractive index of the second multiple refractive index layer is less than a refractive index of the base layer,
the effective refractive index of the first multiple refractive index layer is calculated by Equation (15) below:
$$ne {1}^{2} = n {1}^{2} \times f 11 + n {2}^{2} \times f 12 \qquad Equation ( 15 )$$
wherein ne1 is the effective refractive index of the first multiple refractive index layer, n1 is the first refractive index of the first refractive index layer, f11 is a ratio of the thickness of the first refractive index layer to a total thickness of the first multiple refractive index layer, n2 is the second refractive index of the second refractive index layer, and f12 is a ratio of the thickness of the second refractive index layer to the total thickness of the first multiple refractive index layer, and
the effective refractive index of the second multiple refractive index layer is calculated by Equation (16) below:
$$ne {2}^{2} = n {3}^{2} \times f 21 + n {4}^{2} \times f 22 \qquad Equation ( 16 )$$
wherein ne2 is the effective refractive index of the second multiple refractive index layer, n3 is the third refractive index of the third refractive index layer, f21 is a ratio of the thickness of the third refractive index layer to a total thickness of the second multiple refractive index layer, n4 is the fourth refractive index of the fourth refractive index layer, and f22 is a ratio of the thickness of the fourth refractive index layer to the total thickness of the second multiple refractive index layer.

19. The beam splitter of claim 18, wherein a first center wavelength of a transmission area of the second light transmitted through the first multiple refractive index layer is calculated by Equation (17) below:
$$dt 1 = ( no \times λ21 ) / ( 4 \times ne 1 \times cos θ e 1 ) \qquad Equation ( 17 )$$
wherein dt1 is the total thickness of the first multiple refractive index layer, no is an odd number, λ21 is the first center wavelength of the transmission area of the second light, ne1 is the effective refractive index of the first multiple refractive index layer, and θe1 is the effective refraction angle of the first multiple refractive index layer, and
the second center wavelength of the transmission area of the second light transmitted through the second multiple refractive index layer is calculated by Equation (18) below:
$$dt 2 = ( no \times λ22 ) / ( 4 \times ne 2 \times cos θ e 2 ) \qquad Equation ( 18 )$$
wherein dt2 is the total thickness of the second multiple refractive index layer, no is an odd number, λ22 is the second center wavelength of the transmission area of the second light, ne2 is the effective refractive index of the second multiple refractive index layer, and θe2 is the effective refraction angle of the second multiple refractive index layer.

20. The beam splitter of claim 11, further comprising an anti-reflection layer provided on one side of the base layer and configured to prevent reflection of the second light transmitted through the multiple refractive index layer.

21. A defective element detection device comprising:
the beam splitter using the multiple refractive index layer of claim 1, configured to reflect first light incident from an inspection target element and transmit second light having a wavelength longer than a wavelength of the first light incident from the inspection target element;
a first image generator configured to generate first image information by receiving the first light reflected from the beam splitter using the multiple refractive index layer;
a second image generator configured to generate second image information by receiving the second light transmitted through the beam splitter using the multiple refractive index layer; and
a determiner configured to determine whether the inspection target element is defective, based on the first image information and the second image information.

22. The defective element detection device of claim 21, wherein a length of a first optical path connecting the first image generator to the inspection target element is formed to be greater than a length of a second optical path connecting the second image generator to the inspection target element.

23. The beam splitter of claim 1, further comprising an anti-reflection layer provided on one side of the base layer and configured to prevent reflection of the second light transmitted through the multiple refractive index layer.
